(19) United States
(12) Patent Application Publication
(10) Pub. No.: US 2013/0070565 A1
(43) Pub. Date: Mar. 21, 2013

(54) SEABED INSTALLATIONS

(71) Applicants: Frank L. Eisenhower, Godalming (GB); Richard Edward Luff, Godalming (GB); Iain Jarvies, London (GB)

(72) Inventors: Frank L. Eisenhower, Godalming (GB); Richard Edward Luff, Godalming (GB); Iain Jarvies, London (GB)

(73) Assignee: TGS GEOPHYSICAL COMPANY (UK) LIMITED, Godalming, Surrey (GB)

(21) Appl. No.: 13/698,729

(22) PCT Filed: May 19, 2011
(86) PCT No.: PCT/GB11/00764

§ 371 Date: Nov. 19, 2012

(30) Foreign Application Priority Data
May 20, 2010 (GB) 1008467.1

(51) Int. Cl. G01V 1/20; F16L 1/16

(52) U.S. Cl. 367/154; 405/158

(57) ABSTRACT

There is described a method and apparatus for deploying and covering undersea seismic sensing cables to improve seismic coupling between the sensors of the cable and the seabed. The method comprises simultaneously deploying a submarine seismic cable and a mat in order to cover at least the sensor units of the cable. The mat may be attached to the cable prior to laying the cable on the seabed, and is preferably simultaneously laid with the cable by unwinding the cable and mat from a drum. The mat may be continuous, or may be in discrete sections attached to the cable at spaced locations. The mat or mat sections may comprise a sediment-trapping formation such as a number of upstanding fronds on their upper surfaces

The present invention concerns seismic cable arrays in seabed installations, and is particularly concerned with improving the seismic coupling between the sensors of a seismic cable array and the seabed.

In order to collect data for geological exploration and monitoring of subsurface formations below the sea bed, arrays of seismic sensors are deployed on the seabed. A seismic sensor array comprises a number of underwater sensing units connected together in a string by a sensor cable. The sensing units may be simply laid on the seabed, where they rely on their own weight to push them into contact with the seabed in order to achieve seismic coupling with the seabed. The connecting cable may likewise be simply laid on the seabed, where it is vulnerable to snagging by fishing equipment or ship's anchors.

To protect the connecting cable, to reduce signal noise generated by movements of the connecting cable by sea floor currents and fauna, and to improve seismic coupling between the seabed and the sensors, it has been conventional to bury the sensors and their connecting cable in a trench formed in the seabed. However, although this method of installing subsea seismic sensors improves coupling between the sensor and the seabed, and reduces cable noise by damping out longitudinal and transverse vibrations in the cables, the method is expensive and requires sophisticated equipment to form a trench in the seabed and place the cable therein. Equipment may also be required to fill in the trench after the cable has been placed. Cables which have been buried are also difficult to retrieve for servicing or repair, or when they are required to be deployed to other locations.

The present invention seeks to provide apparatus and methods which enable a seismic cable to be effectively installed on the seabed without the need to form and fill in a trench before and after laying the cable, while providing effective seismic coupling between the sensors of the seismic cable and the seabed, and suppressing cable-induced noise.

The present invention seeks to provide methods and apparatus which achieve the effect of burying a submarine sensor of a seismic cable, by providing or forming a layer above the sensor and optionally also the seismic cable, which layer acts to press at least the sensors into close contact with the seabed. The weight in water of the layer should be sufficient to ensure effective seismic contact between the sensors and the seabed, while inhibiting noise produced at the sensors by motion of the connecting cable. The layer may be a man-made layer such as a strip or mat of negatively buoyant material. Alternatively, the layer may include a layer of sediment which is formed by laying a sediment-trapping formation over the cable. The sediment-trapping formation may comprise a negatively-buoyant base layer or strip having on one face a plurality of upstanding fronds or projections which, when the strip is a deployed on a seabed, extend upwardly into the water column and trap passing sediment particles, causing them to form a depositional cover to the sensors and optionally the cable. In a further alternative, the sediment-trapping formation may comprise a negatively-buoyant base layer or strip having attached thereto marine organisms such as kelp or the like which will grow into upstanding formations which trap passing sediment particles. In addition or as an alternative, the organisms may grow downward to anchor the cable and/or sensors to the seabed. The base layer or strip may be provided with artificial upstanding fronds in addition to marine organisms.

The present invention further seeks to provide an apparatus and methods by means of which a seismic cable may be laid and the sensors of the seismic cable may be effectively coupled to the seabed in a single operation.

According to a first aspect of invention, a method of laying a seismic cable having a number of sensor units and a connecting cable includes placing a negatively buoyant mat over a sensor unit of the cable in order to press the sensor unit to the seabed. Each sensor unit of the seismic cable may be provided with a mat. The mats may be attached to the sensor units or to the cable adjacent the sensor units. The sensor units and mats may be stored on a drum by winding the cable round the drum and laying each mat over the already wound coils, with subsequent coils being laid over mats already wound.

According to a second aspect of the invention, there is provided a cable deployment package comprising a cable drum on which is wound a cable assembly comprising a cable and a mat attached to the cable.

According to a third aspect of the invention, there is provided a submarine cable assembly comprising a cable and a mat attached to the cable. The mat may extend along substantially the entire length of the cable. Alternatively, the mat may comprise a plurality of mat sections which are attached to the cable at locations spaced along its length. The submarine cable may be a seismic cable, which has a plurality of sensor units spaced along the length of the cable.

The mat may simply be a sheet of negatively buoyant material which, in use, overlies the sensor unit. The material of the mat may be selected to ensure it is negatively buoyant in sea water, with an effective in-water weight of up to about 10 kg/m, and typically around 1 kg/m, of mat length (although it may be lighter or heavier than this).

The mat may be provided with a recess or other formation on its underside to locate the mat relative to a sensor unit of the seismic cable. The mat may have mass concentrated above a recess in its underside which receives the sensor unit of the seismic cable. Fixing means may be provided to attach the mat to the sensor unit, or to the cable. The mat may be a sheet of substantially uniform thickness, or may be tapered towards its periphery to provide a thickened central area and thinned edges.

The mat may comprise a substantially planar rubber sheet, with heavy metallic or other inserts positioned to weigh down a sensor unit beneath the mat. The lower surface of the mat may be adapted to inhibit relative movement between the mat and the cable, and between the mat and the seabed, and so reduce or prevent motion of the cable relative to the seabed. This reduction in movement of the cable reduces unwanted signal noise, and improves sensing accuracy. To reduce relative movement, the underside of the mat may be formed from, or coated with, a material selected to maximise friction between the mat and the cable, and/or the mat and the seabed. Alternatively or additionally, the underside of the mat may be formed with projections such as ridges or spikes to inhibit this relative movement.

In an alternative embodiment, the mat may be a continuous length or strip of material which extends the entire length of the seismic cable. The cable may be attached to the mat at intervals in order to preserve the relative positioning of the mat and the cable. The strip may be formed at intervals with recesses to accommodate the sensor units of the seismic cable.

If an alternative embodiment, the mat may comprise a woven base strip from one side of which ribbons or fronds extend. The base strip is made negatively buoyant, and the ribbons or fronds may be made from buoyant material, so that when the strip is laid on the seabed over the cable, and ribbons or fronds are drawn by their buoyancy to extend upwardly from the base strip. Alternatively, the ribbons or fronds may be flexible and resilient, and may be fixed to the base strip so that they extend upwardly from the base strip when unstressed. In this arrangement, passing sediment particles become caught in the fronds and sink down to accumulate on top of the base strip, eventually burying the base strip and its underlying cable and sensor units.

The base strip may be flexible, and may be provided along its edges with stiffening elements such as rubber edging strips whose thickness tapers in the direction away from the centre of the mat. Metallic wires may be provided to extend along the edges of the base strip. The metallic wires may extend within the stiffening elements. The woven mat may be formed from plastics materials such as polyester or polypropylene. The fronds may be formed from buoyant plastics material, possibly a biodegradable type of plastics material. Alternatively, the fronds may be negatively or neutrally buoyant but may have a float attached to their free end to hold them upright when deployed in water.

In a further alternative embodiment, the mat or strip may simply be a negatively buoyant strip of material, to which have been attached the seeds or spores of marine vegetation or juvenile marine organisms, suitable to the area where the strip is to be laid, so that after laying the strip the vegetation or organisms will grow and extend upwardly to entrap passing sediments to achieve a passive burial of the cable, and/or downwardly to anchor the mat to the seabed.

A fourth aspect of the invention provides a deployment package for an undersea cable and burial strip, the package comprising a drum on which the cable is wound with its burial strip attached to the cable. The cable and burial strip is simultaneously unwound from the drum for deployment on the seabed, with the cable overlain by the burial strip. The deployment package may be positioned on board a surface vessel during unwinding of the cable and the burial strip, with the cable and burial strip being fed overboard to be laid on the seabed. Alternatively, the deployment package may be suspended from a surface vessel so that the package is adjacent the seabed, and the cable and burial strip may then be unwound from the package onto the seabed. The burial strip may be discontinuous, and may comprise a plurality of burial mats attached to the cable at spaced locations along the length of the cable.

A fifth aspect of the invention provides an undersea cable assembly, in which the cable has attached to it a burial strip or a series of burial mats at locations along the length of the cable. The cable assembly may be a seismic cable having sensor units spaced along its length, and having a burial mat attached to the cable at the location of each sensor unit.

Embodiments of the invention will now be described in detail with reference to the accompanying Figures, in which:

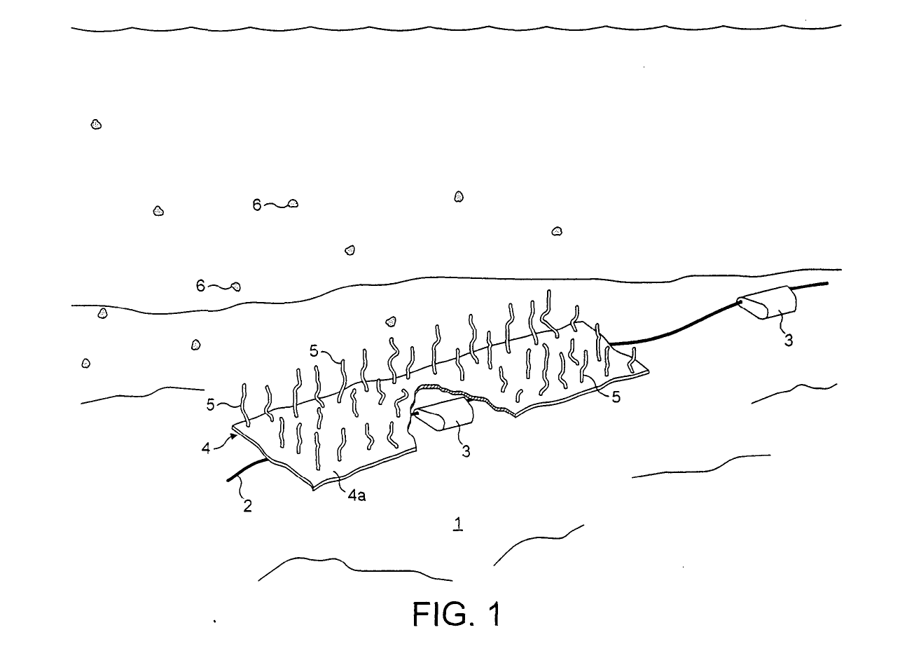

FIG. 1 is a perspective view of a seismic cable and a section of burial mat;

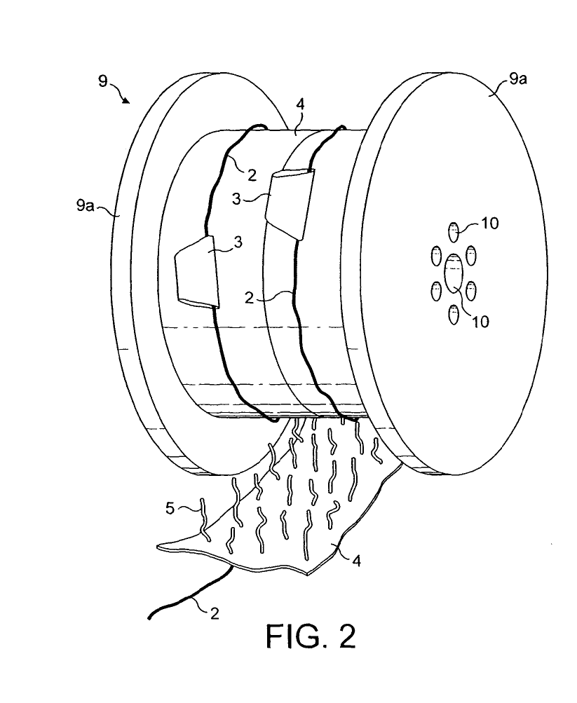

FIG. 2 is a perspective view showing two seismic cables and their respective burial mats wound on a cable drum;

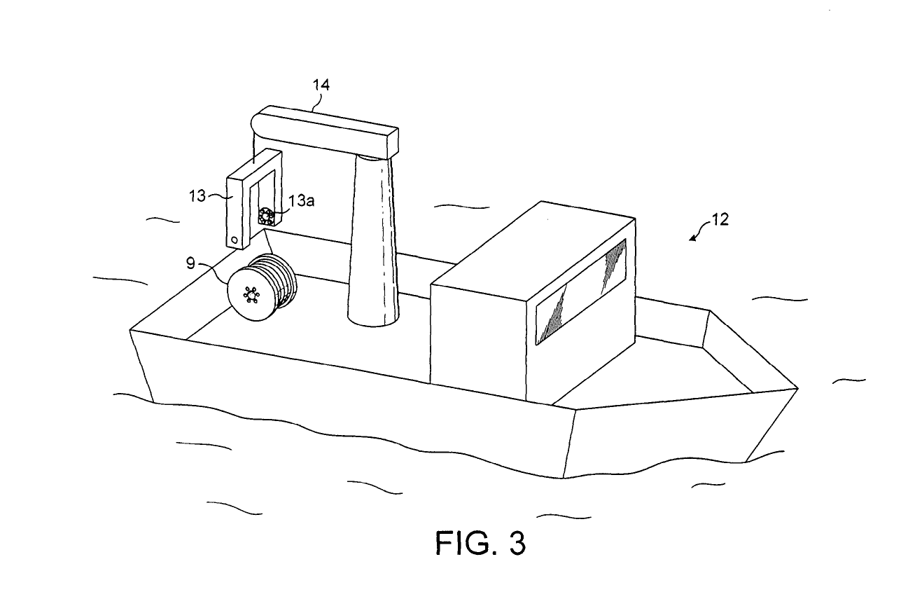

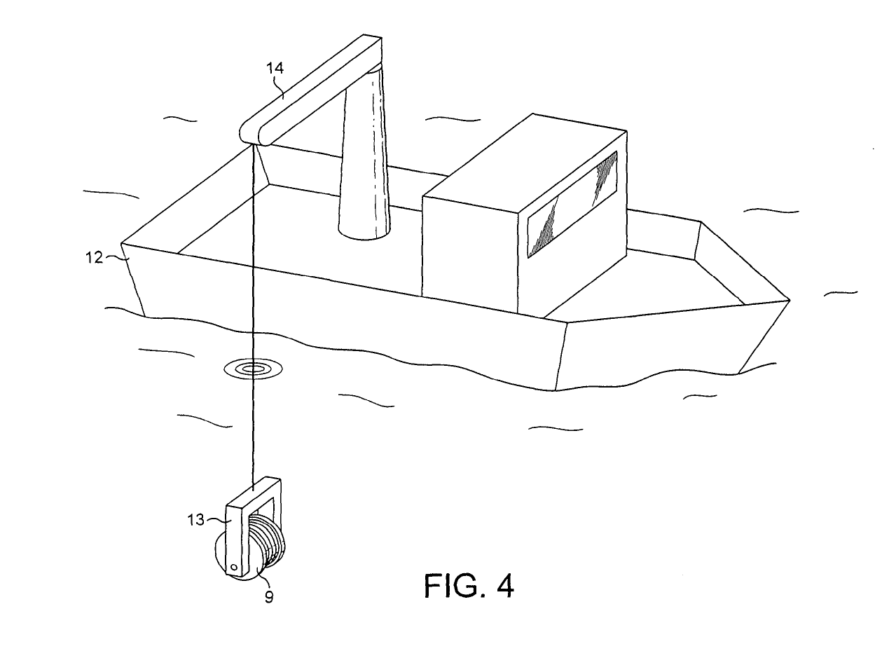

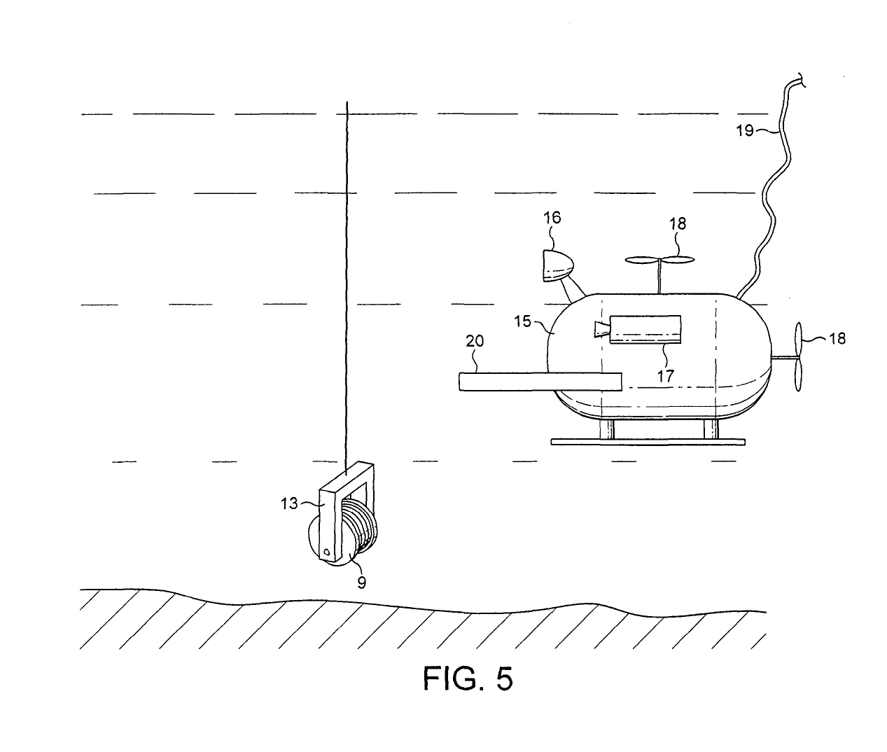

FIGS. 3 to 6 schematically illustrate stages in the deployment of a seismic cable and its burial mat;

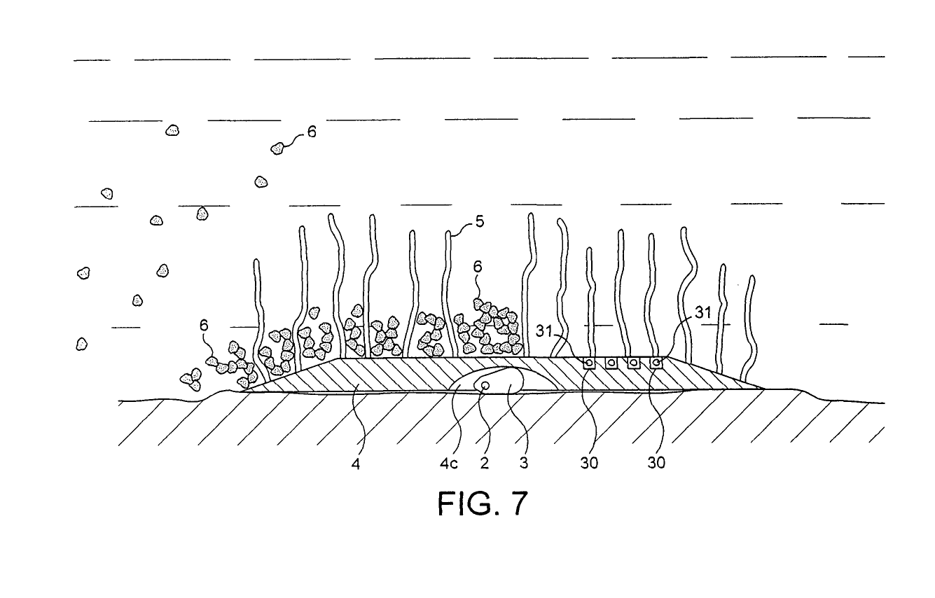

FIG. 7 is a cross-sectional view of a seismic cable and burial mat laid on a seabed; in

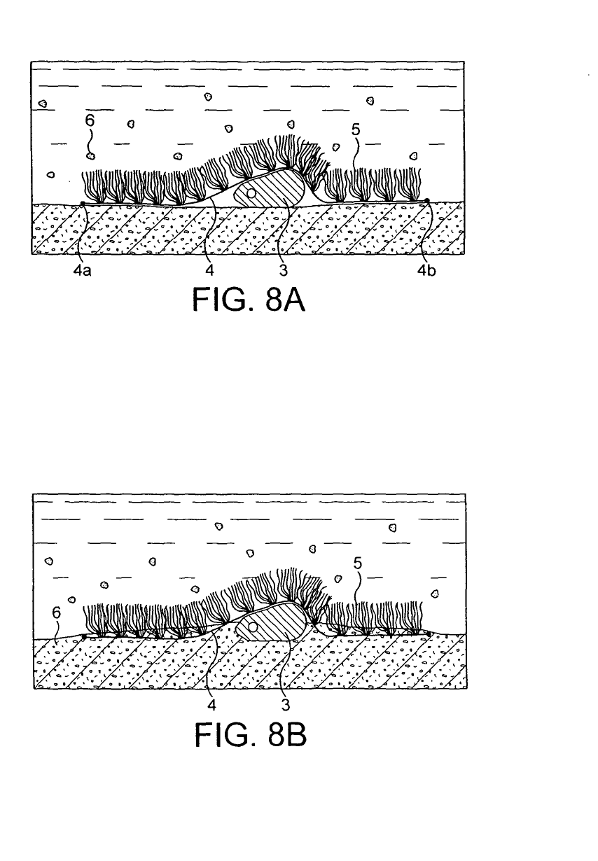

FIGS. 8A to 8D are cross-sectional views showing stages in the self-burying process;

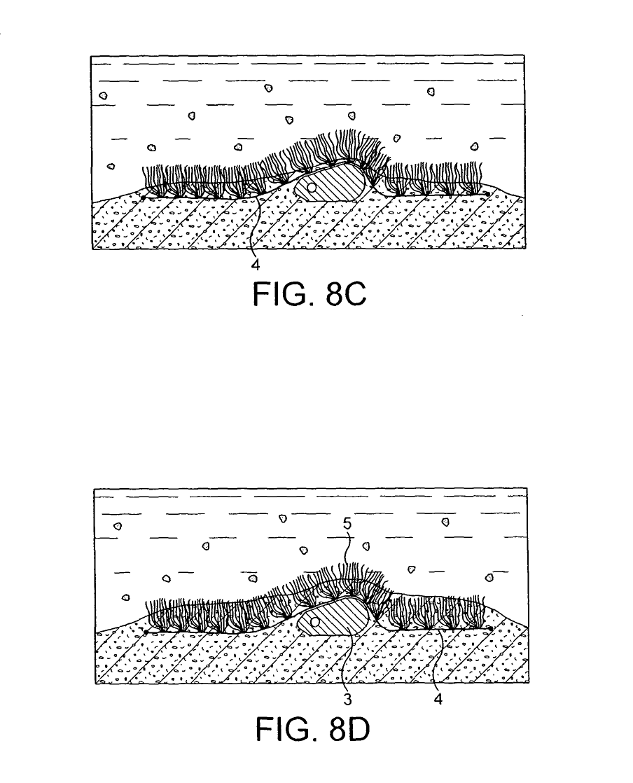

FIG. 9 is a perspective view of an alternative embodiment of the invention in the form of an individual mat placed over a sensor unit; and

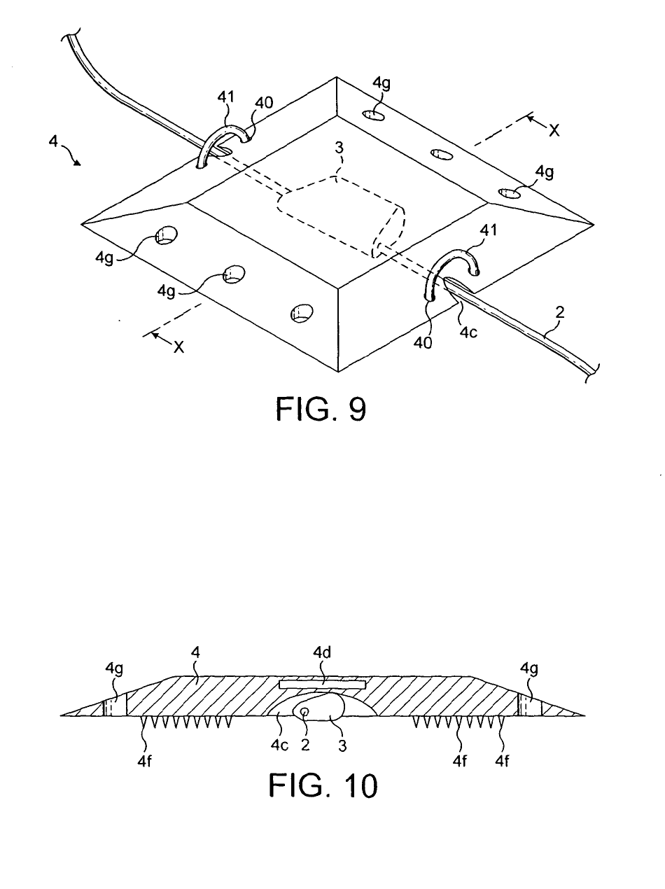

FIG. 10 is a sectional view of the mat of FIG. 9 on the line X-X.

Referring now to the Figures, FIG. 1 illustrates part of a seabed 1 on which a seismic cable 2 has been laid. The seismic cable 2 comprises a number of sensor units 3 spaced along its length at predetermined positions.

A burial mat 4 is laid over the seismic cable 2 and the sensor units 3, only a section of the mat being shown in FIG. 1. The mat is preferably a continuous length of mat which covers the entire length of the seismic cable 2. In the Figure, part of the mat is cut away to show the sensor unit 3 beneath the mat. The mat may be from 10 cm to 2 m in width, and is preferably formed from a woven fabric. The fabric may be woven from polypropylene or polyester, with suitable additives to increase the density of the material so that it is negatively buoyant and will sink to the seabed when deployed. Alternatively the mat may be made from a rubber or plastic, or other material with similar properties. One or both of the edges of the mat may be provided with a continuous strip of “heavy” material such as metallic wire or a rubber strip, to ensure that the edges of the mat remain on the seabed when deployed. Where a metallic wire is provided, correct positioning of the strip may be ensured by detecting the presence of the metallic wire and controlling deployment of the cable and the mat or strip on the basis of the detection result.

The mat may be attached to the seismic cable by ties which extend through the mat and round the cable, with ties being placed adjacent the ends of each sensor unit to anchor the mat longitudinally in relation to the seismic cable. Alternatively, the woven material of the mat may include the seismic cable as a central warp thread, the mat being woven around the seismic cable.

The mat comprises a negatively-buoyant base layer 4a, to the upper surface of which are attached a plurality of elongate flexible buoyant fronds 5. The fronds 5 are elongate, and may be between 10 cm and lm in length. The fronds are each attached at one of their ends to the base 4a of the mat 4. When the base 4a is laid on the seabed, the fronds 5 are lifted to substantially vertical positions by their buoyancy, and are sufficiently flexible to “wave” with the current or tide. Preferably, the entire upper surface of the mat is furnished with fronds, each frond being preferably spaced from its neighbour by from about 1 to about 20 cm. The purpose of the fronds is to entrap passing particles 6 carried on the ocean current, so that they accumulate between the fronds and build up a sediment layer on top of the base 4a of the mat.

FIG. 2 shows a schematic perspective view of a cable drum 9 carrying two seismic cables 2 and their respective mats 4. The seismic cables are fixed to the undersides of their respective mats, by means of ties or by formations such as clips or channels on the underside of the mats to engage the seismic cables and retain them in position. More than two cables may be wound on the same drum. The cables and their respective mats may be wound on to the drum 9 in the same or in opposite directions.

As the cables are wound on to the drum, the fronds 5 extending from the upper surfaces of the mats are folded down between successive coils of the base 4a of the mat. Although in the embodiment shown the cable drum 9 carries two seismic cables, it is foreseen that the drum may carry a single cable, or may carry three or more cables, with the axial distance between end plates 9a of the drum being adjusted accordingly. At least one of the end plates 9a of the cable drum is formed with central openings 10 or other formations to enable the drum to be engaged, lifted and optionally also driven in rotation.

FIGS. 3 to 6 illustrate stages in the deployment of a seismic cable in accordance with the invention. In FIG. 3 the cable drum 9, with the seismic cable 2 and mat 4 wrapped on it, is transported to the deployment site by means of a support vessel 12. At the deployment site, the cable drum 9 is engaged by a drum frame 13 and lifted by a crane 14, which then lowers the drum frame 13 and the cable drum 9 overboard. The drum frame 13 has formations 13a that engage the formations 10 on the end plates 9a of the drum 9 and enable the drum to rotate relative to the drum frame 13.

At the same time that the drum 9 and drum frame 13 are lowered overboard, a submarine vehicle 15 such as an ROV is deployed to the seabed at the deployment site. The ROV 15 comprises lights 16, a camera system 17 and control thrusters 18. The ROV may be controlled from the support vessel 12 via an umbilical cable 19.

The ROV 15 further includes an engagement and drive means 20 which is engagable with the drum frame 13, so that the ROV 15 may be locked to the drum frame 13, and may apply a rotational driving force to the cable drum 9. Alternatively, the drive means may be integral with the drum frame and the ROV may engage the drum frame 13 to control the drive means and supply power in the form of hydraulic pressure or electric current to the drive means. In a further alternative, the drum frame may be provided with a drive means supplied with electrical or hydraulic power from the surface vessel through a cable or hose.

In the embodiment illustrated, the weight of the drum 9 and the drum frame 13 is carried by the crane 14 of the support vessel 12, and thus the ROV 15 needs only sufficient power to guide the drum frame 13 and move the drum frame and cable drum 9 over the seabed.

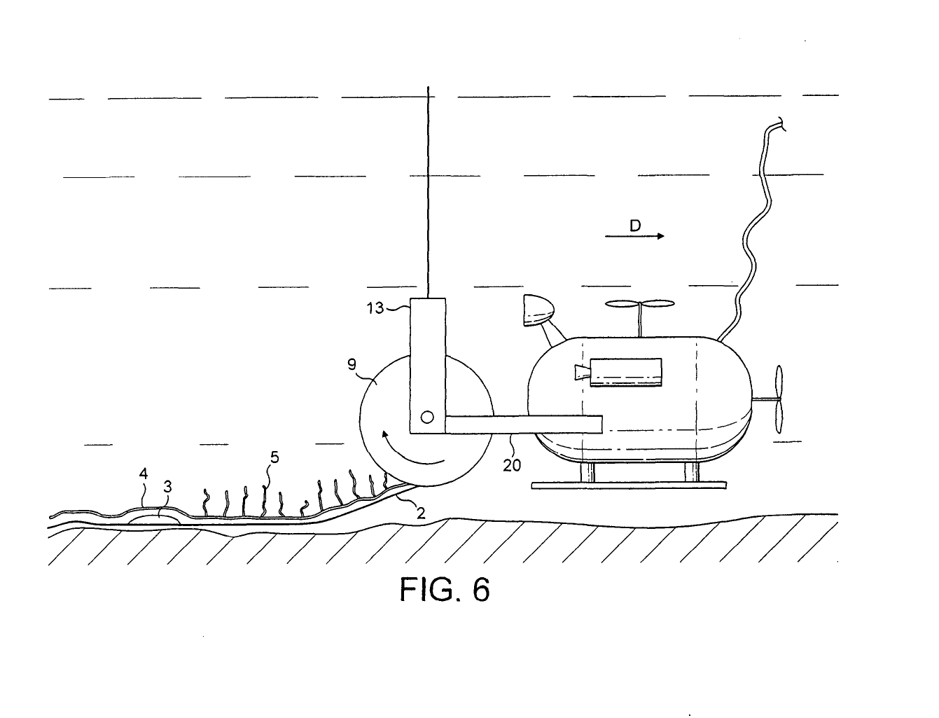

In the embodiment shown, the ROV 15 guides the cable drum to the required position for one end of the seismic cable, and then commences rotation of the drum 9 to pay out the seismic cable 2 and the mat 4 onto the seabed while simultaneously moving the drum 9 and drum frame 13 over the seabed in the direction D in which the seismic cable 2 is to extend. The drum is preferably suspended up to about 2 m above the seabed during the deployment process. As can be seen in FIG. 6, this will result in the seismic cable 2 and its sensor units 3 being laid on the seabed, with the mat 4 overlying the cable 2 and sensor units 3. The fronds 5, which had been folded flat between coils of the mat 4 while on the drum 9, will assume an upstanding position when the mat is laid on the seabed, either due to the buoyancy of the fronds, or by the resilience of the fronds.

As an alternative to driving the drum in rotation, the end of the cable may be first anchored to the seabed, and then the ROV used to guide the cable drum away from the anchoring point, using tension in the cable to cause rotation of the drum and thus draw the cable and mat off the drum.

When the entire length of the cable 2 and mat 4 have been paid off the drum 9, the drive means 20 of the ROV 15 is disengaged from the drum frame 13. The drum frame and empty drum are then hoisted by the crane 14 back on board the support vessel 12, and the empty drum 9 is removed from the drum frame 13. A fresh drum 9 wound with a further length of seismic cable and mat is attached to the drum frame, and is hoisted overboard and lowered to the seabed for engagement with the drive means 20 of the ROV 15. The process of unwinding the cable and mat along the seabed is then repeated.

In a final operation, connections between the seismic cables 2 and a riser may be made at a previously or subsequently installed seabed hub, so that the sensor units 3 of the seismic cables may be interrogated. These connections may be made by any suitable method known to those skilled in the art, and will not be described in detail here.

In an alternative deployment method, the seismic cable and mat may be laid in two separate operations. The seismic cable and sensor units are first deployed on the seabed, preferably by unwinding the seismic cable from a cable drum in a manner similar to that disclosed above. A drum wound only with the mat is then lowered to the seabed and the mat is laid over the length of the seismic cable by guiding the drum above the seismic cable and paying out the mat by rotating the drum.

In a further embodiment of the invention, a seismic cable and mat may be laid on the seabed by being paid out overboard from a cable drum mounted on a surface vessel.

As the mat is unwound onto the seabed, the fronds 5 are moved from the laid-flat condition between the coils of the mat to substantially upright positions by their buoyancy or resilience. The fronds 5 then entrap sediment particles borne by the ocean currents, which then sink down adjacent the fronds and build up a sediment layer on the mat 4. FIGS. 8A to 8D illustrate stages in the buildup of this sediment layer. In FIG. 8A, there is seen in cross section a mat 4 with fronds 5 overlying a sensor unit 3 of a seismic cable on the seabed, in its “freshly laid” condition. The edges of the mat 4 in this embodiment are initially held to the seabed by weighted edge strips 4b.

FIG. 8B illustrates the condition of the mat after a period of about three months, and an amount of sediment 6 has been trapped by the fronds 5 and has built up on the mat 4, burying the base of the mat.

FIG. 8C illustrates the condition after approximately 6 months, and it can be seen that a substantial sediment layer has built up, covering the sensor unit 3. After about nine months, as seen in FIG. 8D, the sensor unit 3 and mat 4 are completely buried, with only the tips of some of the fronds projecting above the layer of sediment. The amount and rate at which sediment builds up will depend largely on the speed of ocean currents or tides passing the site, and the amount of sediment carried on those currents. The illustrations of FIGS. 8A to 8D may represent the sediment in the build-up at intervals of less than or more than three months, depending on the amount of sediment carried to the site by the current, and trapped by the fronds.

In an alternative embodiment of the invention, the mat does not have fronds fitted to the upper surface. Instead the mat has a structure and weight sufficient to achieve a similar effect to the sediment, and thus couple the sensors to the seabed. In this embodiment, the total in-water weight of the mat may be of the order of from 1 to 10 kg/m length of mat. The mat in this case may be formed of an extruded rubber or plastics material, or other suitable material with equivalent in-water weight.

The lower surface of the mat may be designed to maximise friction between the mat and the cable, and/or between the mat and the seabed—for instance, by using rubber with a high coefficient of friction, or by using a series of parallel ridges or spikes formed on the lower surface of mat. These ridges or spikes may have a depth in the range of from 1 mm to 1 cm or more. The friction between the mat, cable and seabed inhibits, and preferably prevents, unwanted motion of the cable relative to the seabed and sensor units.

FIG. 7 is a cross-sectional view which illustrates an alternative embodiment of the mat, in which the mat 4 is formed by a thick layer of extruded rubber or plastics material. The mat 4 has recesses 4c on its underside to accommodate the seismic cable 2 and sensor units 3, and is tapered at its edge regions. The upper surface of the mat 4 may be formed with flexible buoyant fronds 5, or alternatively may be seeded with juvenile marine organisms 31 such as kelp, anemones or other marine vegetation. Once deployed on the seabed, these organisms will grow to form sediment-trapping formations extending upwardly from the mat 4, and a layer of sediment 6 will build up on the mat 4. The upper surface of the mat may be formed with small recesses 30, or patterned with ribs, in order to retain the marine organisms 31 prior to deployment of the mat. The recesses 30 may extend down through the mat, to allow roots to grow down through the recess and into the seabed to further anchor the mat. The marine organisms may be accommodated and restrained in the recesses 30 in the mat by placing one or more organisms 31 within a recess 30, and by filling the recess with a nutrient gel.

FIGS. 9 and 10 show a further alternative embodiment of the invention, in which individual mats are attached to a seismic cable 2 to cover the sensor units 3 of the cable. In this embodiment, coupling of the sensor unit 3 to the seabed is achieved simply by the weight of the mat 4, and no sediment-trapping formations are provided. However, alternative embodiments are envisaged in which individual mats attached to respective sensor units are provided with sediment-trapping formations, or with marine organisms which will eventually form such formations. The mat is preferably flexible enough to conform to the seabed, and is preferably formed with a recess 4c on its undersurface to accommodate the sensor unit 3 which it covers. The mat may include additional weights 4d within or attached to the mat in order to increase the downward force pressing the sensor unit onto the seabed. In the illustrated embodiment, the mat is formed with openings 40 through which ties 41 extended to surround the cable 2 and secure the cable to the mat. The cable 2 may be accommodated in a groove 4e in the underside of the mat, which opens into the recess 4c. Alternatively or additionally, the mat may be attached to the sensor unit by bonding. In addition, the lower surface of the mat may be designed to maximise friction between the mat and the cable, and the mat and seabed, by appropriate choice of materials and/or by forming ridges or spikes 4f or other patterning in the lower surface of the mat. The mat may also be designed with an open structure, incorporating holes 4g through the cross-section of the mat, to maximise grip between the mat and the seabed material so as to prevent movement of the mat along the seabed.

The mat may also be fixed to the seabed at intervals by fixtures which are driven through the mat or through holes in the mat into the seabed. These fixtures may be metal spikes several cm in length.

Although the mat illustrated in FIG. 9 is generally square in form, it is to be understood that the mat may be of any convenient shape, such as circular, hexagonal or triangular. The mat may be typically approximately lm across, although narrower versions are possible which could be as little as 10 cm across. In one embodiment, the mat may be formed integrally with a housing of the sensor unit 3.

The cable and mat illustrated in FIGS. 9 and 10 may be deployed to the seabed by a method similar to that described in relation to FIGS. 3 to 6, the seismic cable with its mats attached being wound on to a cable drum for transport to the deployment site.

In the embodiments described above, deployment of the cables on the seabed is achieved by unwinding the cable and mat or mats from a drum supported from a surface vessel and whose movement is controlled by a swimming vehicle. It is to be understood that a wheeled or tracked vehicle running on the seabed could be used to support and/or guide the drum during the deployment process, or a free-swimming ROV could be provided with sufficient power to both support and guide the cable drum during the deployment process. In a yet further deployment method, the drum may be positioned on board a surface vessel and the cable and mats may be deployed by feeding them overboard from the surface vessel and down to the seabed. The final positioning of the cable and mat or mats may be controlled by an ROV, either free-swimming or moving along the seabed.

1. A submarine cable assembly comprising:
a seismic cable comprising a number of sensor units spaced along the length of a connecting cable; and
a mat attached to the cable and adapted to overlie at least one sensor unit of the seismic cable on a seabed.

2. A submarine cable assembly according to claim 1, wherein the mat is a continuous strip extending along the length of the seismic cable.

3. A submarine cable assembly according to claim 1, wherein the mat comprises a number of separate mat sections, each mat section associated with a location along the length of the seismic cable.

4. A submarine cable assembly according to claim 3, wherein the location of a mat section corresponds to the position of a sensor unit.

5. A submarine cable assembly according to claim 3, wherein the undersurface of the mat section includes a recess to accommodate the cable and/or a sensor unit.

6. A submarine cable assembly according to claim 4, wherein the mat section is bonded to the sensor unit.

7. A submarine cable assembly according to claim 1, wherein the upper surface of the mat or mat section has sediment-trapping formations.

8. A submarine cable assembly according to claim 7, wherein the sediment-trapping formations are flexible fronds extending upwardly from the mat or mat section when deployed.

9. A submarine cable assembly according to claim 7, wherein the mat or mat section is provided with marine organisms selected to form sediment-trapping formations.

10. A submarine cable assembly according to claim 9, wherein the mat or mat section is formed with recesses on its upper surface to accommodate marine organisms.

11. A submarine cable assembly according to claim 9, wherein the mat is formed with recesses extending from its upper surface to its undersurface to accommodate marine organisms.

12. A submarine cable assembly according to claim 1, wherein the mat or mat section is fixed to the cable by means of ties extending through the mat or mat section and round the cable.

13. A submarine cable assembly according to claim 1, wherein the cable is attached to the mat or mat section by being received within recessed formations in the underside of the mat or mat section.

14. A submarine cable assembly according to claim 1, wherein the mat or mat section comprises a woven material and the cable forms a warp thread of the woven material.

15. A submarine cable assembly according to claim 14, wherein edges of the mat or mat section are weighted.

16. A submarine cable assembly according to claim 15, wherein the weighted edges comprise triangular-section rubber extrusions.

17. A submarine cable assembly according to claim 15, wherein the weighted edges comprise metallic wires.

18. A submarine cable assembly according to claim 1, where the underside of the mat is adapted to inhibit relative movement between the mat and the cable and between the mat and the seabed.

19. A submarine cable assembly according to claim 18, where the underside of the mat is provided with formations to inhibit relative movement between the mat and the cable and between the mat and the seabed.

20. A submarine cable assembly according to claim 19, where the formations to inhibit relative movement comprise ridges or spikes.

21. A submarine cable according to claim 18, where the underside of the mat is made from a friction material.

22. A submarine cable deployment package comprising a drum on which is wound a submarine cable assembly, the submarine cable assembly comprising:
a seismic cable comprising a plurality of sensor units spaced along its length; and
a mat attached to the submarine cable.

23. A deployment package according to claim 22, wherein the mat extends the entire length of the submarine cable.

24. A deployment package according to claim 22, wherein a plurality of mat sections are attached to the submarine cable at respective locations spaced along the length of the cable.

25. A deployment package according to claim 24, wherein respective mat sections are attached to the seismic cable at the locations of sensor units.

26. A method of deploying a submarine cable comprising the steps of:
positioning a drum on which is wound a submarine cable to which a mat has been attached;
simultaneously unwinding the cable and mat from the drum, such that the cable is deployed on to a seabed with the mat overlying the cable

27. A method according to claim 26, in which the drum is supported adjacent the seabed by a drum frame suspended from a surface vessel during unwinding of the cable and mat.

28. A method according to claim 27, in which the drum is guided during unwinding of the cable and mat by a submarine vehicle.

29. A method according to claim 28, in which the submarine vehicle is a remotely controlled swimming vehicle, an autonomous swimming vehicle, or a seabed vehicle.

30. A method according to claim 26, in which the drum is supported on a surface vessel and the cable and mat are fed overboard during unwinding of the cable and mat.

31. A method according to claim 30, in which the cable and mat are guided during unwinding by a submarine vehicle.

32. (canceled)

33. (canceled)

34. (canceled)
